(19) United States
(12) Patent Application Publication
(10) Pub. No.: US 2013/0169937 A1
(43) Pub. Date: Jul. 4, 2013

(54) TILTED DICHROIC COLOR COMBINER I

(71) Applicants: Andrew J. Ouderkirk, Saint Paul, MN (US); Zhisheng Yun, Woodbury, MN (US); Xiaohui Cheng, Singapore (SG)

(72) Inventors: Andrew J. Ouderkirk, Saint Paul, MN (US); Zhisheng Yun, Woodbury, MN (US); Xiaohui Cheng, Singapore (SG)

(73) Assignee: 3M INNOVATIVE PROPERTIES COMPANY, ST. PAUL, MN (US)

(21) Appl. No.: 13/822,381

(22) PCT Filed: Sep. 13, 2011
(86) PCT No.: PCT/US11/51323

§ 371 Date: Mar. 12, 2013

Related U.S. Application Data
(60) Provisional application No. 61/385,237, filed on Sep. 22, 2010.

(51) Int. Cl. G02B 27/10; G03B 21/14

(52) U.S. Cl. CPC G02B 27/1006; G03B 21/14
USPC 353/20; 359/634

(57) ABSTRACT

The disclosure generally relates to color combiners, and in particular color combiners useful in small size format projectors such as pocket projectors. The disclosed color combiners include a tilted dichroic plate having at least two reflectors configured with light collection optics to combine at least two colors of light.

### RELATED APPLICATIONS

This application is related to the following U.S. patent applications, which are incorporated by reference: “Tilted Dichroic Color Combiner II” (Attorney Docket No. 66791US002) and “Tilted Dichroic Color Combiner III” (Attorney Docket No. 66792US002), both filed on an even date herewith.

### BACKGROUND

Projection systems used for projecting an image on a screen can use multiple color light sources, such as light emitting diodes (LED's), with different colors to generate the illumination light. Several optical elements are disposed between the LED's and the image display unit to combine and transfer the light from the LED's to the image display unit. The image display unit can use various methods to impose an image on the light. For example, the image display unit may use polarization, as with transmissive or reflective liquid crystal displays.

Still other projection systems used for projecting an image on a screen can use white light configured to imagewise reflect from a digital micro-mirror (DMM) array, such as the array used in Texas Instruments' Digital Light Processor (DLP®) displays. In the DLP® display, individual mirrors within the digital micro-mirror array represent individual pixels of the projected image. A display pixel is illuminated when the corresponding mirror is tilted so that incident light is directed into the projected optical path. A rotating color wheel placed within the optical path is timed to the reflection of light from the digital micro-mirror array, so that the reflected white light is filtered to project the color corresponding to the pixel. The digital micro-mirror array is then switched to the next desired pixel color, and the process is continued at such a rapid rate that the entire projected display appears to be continuously illuminated. The digital micro-mirror projection system requires fewer pixelated array components, which can result in a smaller size projector.

Image brightness is an important parameter of a projection system. The brightness of color light sources and the efficiencies of collecting, combining, homogenizing and delivering the light to the image display unit all affect brightness. As the size of modern projector systems decreases, there is a need to maintain an adequate level of output brightness while at the same time keeping heat produced by the color light sources at a low level that can be dissipated in a small projector system. There is a need for a light combining system that combines multiple color lights with increased efficiency to provide a light output with an adequate level of brightness without excessive power consumption by light sources.

Such electronic projectors often include a device for optically homogenizing a beam of light in order to improve brightness and color uniformity for light projected on a screen. Two common devices are an integrating tunnel and a fly's eye array (FEA) homogenizer. Fly's eye homogenizers can be very compact, and for this reason is a commonly used device. Integrating tunnels can be more efficient at homogenization, but a hollow tunnel generally requires a length that is often 5 times the height or width, whichever is greater. Solid tunnels often are longer than hollow tunnels, due to the effects of refraction.

Pico and pocket projectors have limited available space for efficient color combiners, light integrators, and/or homogenizers. As a result, efficient and uniform light output from the optical devices used in these projectors (such as color combiners and polarization converters) can require compact and efficient optical designs.

### SUMMARY

The disclosure generally relates to color combiners, and in particular color combiners useful in small size format projectors such as pocket projectors. The disclosed color combiners include a tilted dichroic plate having at least two reflectors configured with light collection optics to combine at least two colors of light. In one aspect, the present disclosure provides a color combiner that includes a first light collection optics having a first light input surface and an optical axis, and a first and a second light source, each displaced from the optical axis and disposed to inject a first and a second color light into the first light input surface. The color combiner further includes a dichroic plate disposed facing the first light collection optics opposite the first light input surface, the dichroic plate including a first dichroic reflector capable of reflecting the first color light and transmitting other color light, and a second reflector capable of reflecting the second color light. The first dichroic reflector and the second reflector are each tilted such that the first and the second color light are both reflected to exit through the first light input surface along the optical axis, as a combined color light beam.

In another aspect, the present disclosure provides a color combiner that includes a first light collection optics having a first light input surface and an optical axis, and a first and a second light source, each displaced from the optical axis and disposed to inject a first and a second color light into the first light input surface. The color combiner further includes a dichroic plate disposed facing the first light collection optics opposite the first light input surface, the dichroic plate including a first dichroic reflector capable of reflecting the first color light and transmitting other color light, and a second reflector capable of reflecting the second color light. The first dichroic reflector and the second reflector are each tilted such that the first and the second color light are both reflected to exit through the first light input surface along the optical axis, as a combined color light beam. The color combiner still further includes a light homogenization tunnel disposed to transmit the combined color light beam to a second light collection optics, the second light collection optics expanding the combined color light beam to become an expanded combined color light beam having a small divergence angle.

In yet another aspect, the present disclosure provides a color combiner that includes a first lens having a first convex surface, a first light input surface opposite the first convex surface, and an optical axis, and a second lens centered on the optical axis, the second lens having a second surface facing the first convex surface, and a third convex surface opposite the second surface. The color combiner further includes a first, a second, and a third light source displaced from the optical axis and disposed to inject a first, a second, and a third color light, respectively, into the first light input surface; and a dichroic plate disposed facing the third convex surface. The dichroic plate includes a first dichroic reflector capable of reflecting the first color light and transmitting the second and the third color light, a second dichroic reflector capable of reflecting the second color light and transmitting the third color light, and a third reflector capable of reflecting the third color light. The first dichroic reflector, the second dichroic reflector, and the third reflector are each tilted such that the first, the second, and the third color light beam are each reflected to exit through the first light input surface along the optical axis as a combined color light beam.

In yet another aspect, the present disclosure provides a color combiner that includes a first lens having a first convex surface, a first light input surface opposite the first convex surface, and an optical axis, and a second lens centered on the optical axis, the second lens having a second surface facing the first convex surface, and a third convex surface opposite the second surface. The color combiner further includes a first, a second, and a third light source displaced from the optical axis and disposed to inject a first, a second, and a third color light, respectively, into the first light input surface; and a dichroic plate disposed facing the third convex surface. The dichroic plate includes a first dichroic reflector capable of reflecting the first color light and transmitting the second and the third color light, a second dichroic reflector capable of reflecting the second color light and transmitting the third color light, and a third reflector capable of reflecting the third color light. The first dichroic reflector, the second dichroic reflector, and the third reflector are each tilted such that the first, the second, and the third color light are each reflected to exit through the first light input surface along the optical axis. The color combiner still further includes a collection optics that includes a third lens having a fourth convex surface, a second light input surface opposite the fourth convex surface, and a light homogenization tunnel disposed on the optical axis and capable of transmitting the light exiting the first light input surface to the second light input surface; and a fourth lens centered on the optical axis, the fourth lens having a fifth surface facing the fourth convex surface, and a sixth convex surface opposite the fifth surface, wherein the light entering the second light input surface exits the sixth convex surface as an expanded light beam having a small divergence angle.

In yet another aspect, the present disclosure provides an image projector that includes a color combiner that includes a first light collection optics having a first light input surface and an optical axis, and a first and a second light source, each displaced from the optical axis and disposed to inject a first and a second color light into the first light input surface. The color combiner further includes a dichroic plate disposed facing the first light collection optics opposite the first light input surface, the dichroic plate including a first dichroic reflector capable of reflecting the first color light and transmitting other color light, and a second reflector capable of reflecting the second color light. The first dichroic reflector and the second reflector are each tilted such that the first and the second color light beam are both reflected to exit through the first light input surface along the optical axis, as a combined color light beam. The color combiner still further includes a light homogenization tunnel disposed to transmit the combined color light beam to a second collection optics, the second collection optics expanding the combined color light beam to become a combined color light beam having a small divergence angle. The image projector further includes a polarization converter disposed to accept the first, the second, and the third color light and output a polarized first, second, and third color light; a spatial light modulator disposed to impart an image to the polarized first, second, and third color light; and projection optics.

In yet another aspect, the present disclosure provides a color combiner that includes a first lens having a first convex surface, a first light input surface opposite the first convex surface, and an optical axis, and a second lens centered on the optical axis, the second lens having a second surface facing the first convex surface, and a third convex surface opposite the second surface. The color combiner further includes a first, a second, and a third light source displaced from the optical axis and disposed to inject a first, a second, and a third color light, respectively, into the first light input surface; and a dichroic plate disposed facing the third convex surface. The dichroic plate includes a first dichroic reflector capable of reflecting the first color light and transmitting the second and the third color light, a second dichroic reflector capable of reflecting the second color light and transmitting the third color light, and a third reflector capable of reflecting the third color light. The first dichroic reflector, the second dichroic reflector, and the third reflector are each tilted such that the first, the second, and the third color light beam are each reflected to exit through the first light input surface along the optical axis. The color combiner still further includes a collection optics that includes a third lens having a fourth convex surface, a second light input surface opposite the fourth convex surface, and a light homogenization tunnel disposed on the optical axis and capable of transmitting the light exiting the first light input surface to the second light input surface; and a fourth lens centered on the optical axis, the fourth lens having a fifth surface facing the fourth convex surface, and a sixth convex surface opposite the fifth surface, wherein the light entering the second light input surface exits the sixth convex surface as an expanded light beam having a small divergence angle. The image projector further includes a polarization converter disposed to accept the first, the second, and the third color light and output a polarized first, second, and third color light; a spatial light modulator disposed to impart an image to the polarized first, second, and third color light; and projection optics.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1A shows a cross-section schematic of a color combiner;

FIG. 1B shows a cross-section schematic of a color combiner;

FIG. 1C shows a cross-section schematic of a color combiner;

FIG. 2 shows a cross-section schematic of a color combiner system;

FIG. 3 shows a schematic diagram of an image projector.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

This disclosure generally relates to image projectors, in particular image projectors having an improved uniformity of light by combining the light using a tilted dichroic reflector plate. In one particular embodiment, the tilted dichroic reflector plate includes a plurality of dichroic filters laminated together, wherein each of the dichroic filters can be tilted at an angle to a normal to the dichroic reflector plate.

In one particular embodiment, a color combiner is described that includes at least two light emitting diodes (LEDs), each with a different color. The light emitted from the two LEDs is collimated into beams that substantially overlap, and the light from the two LEDs is combined and directed into a common area with the combined light beams having a lower etendue and higher brightness than the light emitted by the two LEDs.

The LEDs may be used to illuminate projectors. Since LEDs emit light over an area with a near Lambertian angular distribution, the brightness of a projector is limited by the etendue of the source and the projection system. One method for reducing the etendue of the LED light source is to use dichroic reflectors to make two or more colors of LEDs spatially overlap, such that they appear to be emitting from the same region. Ordinarily, color combiners use the dichroic reflectors at an angle of about 45 degrees. This causes a strong reflective band shift, and limits the useful spectra and angular range of the dichroic reflector. In one particular embodiment, the present disclosure describes an article that combines different color LEDs using dichroic reflectors that are at near normal angles to the incident light beam.

In one aspect, the disclosure provides a compact method of efficiently combining the output from different color light sources. This can be particularly useful for producing illuminators for compact projection systems that are etendue limited. For example, a linear array of red, green, and blue LEDs, where the output of each LEDs is partially collimated by a set of primary optics, is incident on a tilted reflector plate assembly that contains dichroic reflector plates that reflect the red, green, and blue light at different angles. The reflected light is then focused by the primary optics to an aperture that forms a common output for the red, green, and blue LEDs. The common output may be coupled to another set of collection optics that collimates the light emitted by the color combiner. The light emitted by the common output may also be coupled to an integrating rod as described elsewhere. The exit aperture may be centered on the principal axis (for example, the optical axis) of the collection optics, or may be offset from the principal axis. The exit aperture may be in line with the LEDs, or adjacent to the LEDs, or a combination thereof.

The configuration of the 3 LEDs can be expanded to other colors, including yellow and infrared light, as understood by one of skill in the art. The light sources may include lasers combined with LEDs, and may be also be based on an all laser system. The LEDs may consist of a set emitting at least primary colors on short wavelength range of red, green, and blue, and a second set emitting the primary colors on the long wavelength range of red, green, and blue. Further, the aperture at which point the light is mixed may incorporate a Fly Eye Array (FEA) to provide further color integration. This may consist of a one or two dimensional array of lenses, with at least one dimension having 2 to about 20 lenses, as described elsewhere.

LCoS-based portable projection systems are becoming common due to the availability of low cost and high resolution LCoS panels. A list of elements in an LED-illuminated LCoS projector may include LED light source or sources, optional color combiner, optional pre-polarizing system, relay optics, PBS, LCoS panel, and projection lens unit. For LCoS-based projection systems, the efficiency and contrast of the projector is directly linked to the degree of polarization of light entering the PBS. For at least this reason, a pre-polarizing system that either utilizes a reflection/recycling optic or a polarization-conversion optical element, is often required.

Polarization conversion schemes utilizing polarizing beam splitters and half-wave retarders are one of the most efficient ways to provide polarized light into the PBS. One challenge with polarization-converted light is that it may suffer from spatial nonuniformity, leading to artifacts in the displayed image. Therefore, in systems with polarization converters, a homogenization system can be desirable, as described elsewhere.

In one particular embodiment, an illuminator for an image projector includes a light source in which emitted unpolarized light is directed into a polarization converter. The polarization converter separates the light into two paths, one for each polarization state. The path length for each of the two polarization states are approximately equal, and the polarized beams of light can then pass through to a monolithic FEA integrator. The monolithic FEA integrator can cause the light beams to diverge, and the light beams are then directed for further processing, for example, by using a spatial light modulator to impart an image to the light beams, and projection optics to display the image on a screen.

In some cases, optical projectors use a non-polarized light source, such as a light emitting diode (LED) or a discharge light, a polarization selecting element, a first polarization spatial modulator, and a second polarization selecting element. Since the first polarization selecting element rejects 50% of the light emitted from the non-polarized light source, polarization-selective projectors can often have a lower efficiency than non-polarized devices.

One technique of increasing the efficiency of polarization-selective projectors is to add a polarization converter between the light source and the first polarization selecting element. Generally, there are two ways of designing a polarization converter used in the art. The first is to partially collimate the light emitting from the light source, pass the partially collimated beam of light through an array of lenses, and position an array of polarization converters at each focal point. The polarization converter typically has a polarizing beam splitter having polarization selective tilted film (for example MacNeille polarizer, a wire grid polarizer, or birefringent optical film polarizer), where the reflected polarization is reflected by a tilted reflector such that the reflected beam propagates parallel to the beam that is transmitted by the tilted polarization selective film. Either one or the other beams of polarized light is passed through half-wave retarders, such that both beams have the same polarization state.

Another technique of converting the unpolarized light beam to a light beam having a single polarization state is to pass the entire beam of light through a tilted polarization selector, and the split beams are conditioned by reflectors and half-wave retarders such that a single polarization state is emitted. Illuminating a polarization selective spatial light modulator directly with a polarization converter can result in illuminance and color non-uniformity.

In one particular embodiment, a polarization converter can incorporate a fly's eye array (FEA) to homogenize the light in a projection system. The output side of the polarization converter includes a monolithic FEA to homogenize the light. The input and output side of the monolithic FEA include the same number of lenses, with each lens on the output side centered approximately at the focal point of a matching lens at the input side. The lenses can be cylindrical, bi-convex, spherical, or aspherical; however, in many cases spherical lenses can be preferred. The fly's eye integrator and polarization converter can significantly improve the illuminance and color uniformity of the projector, as described elsewhere.

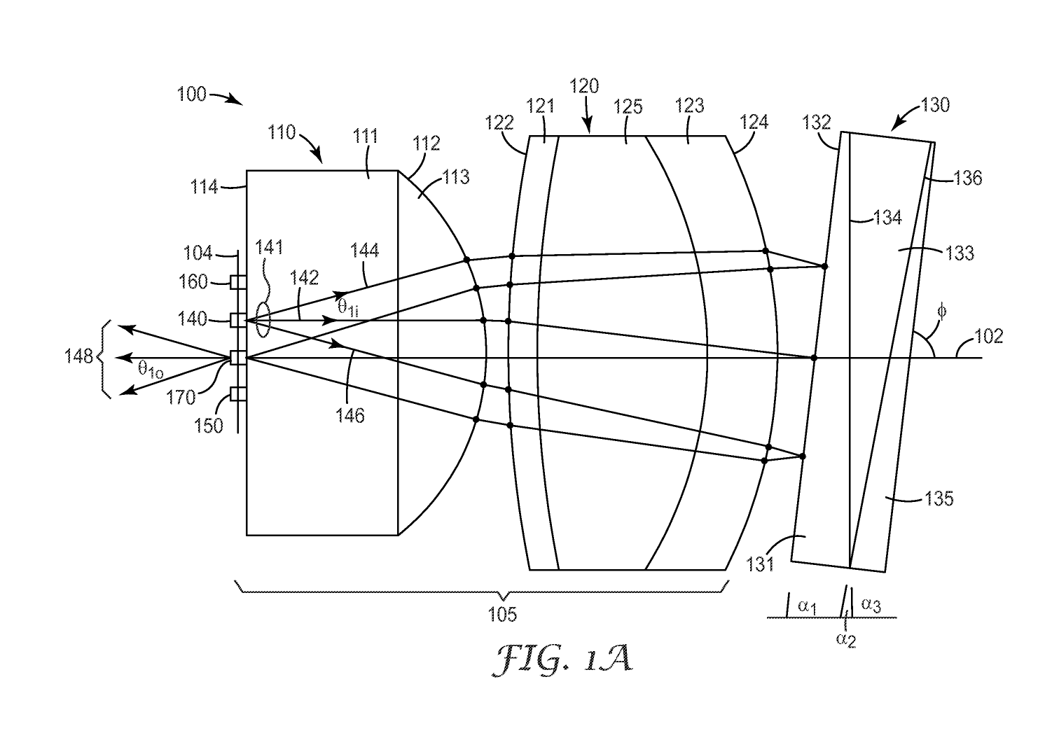

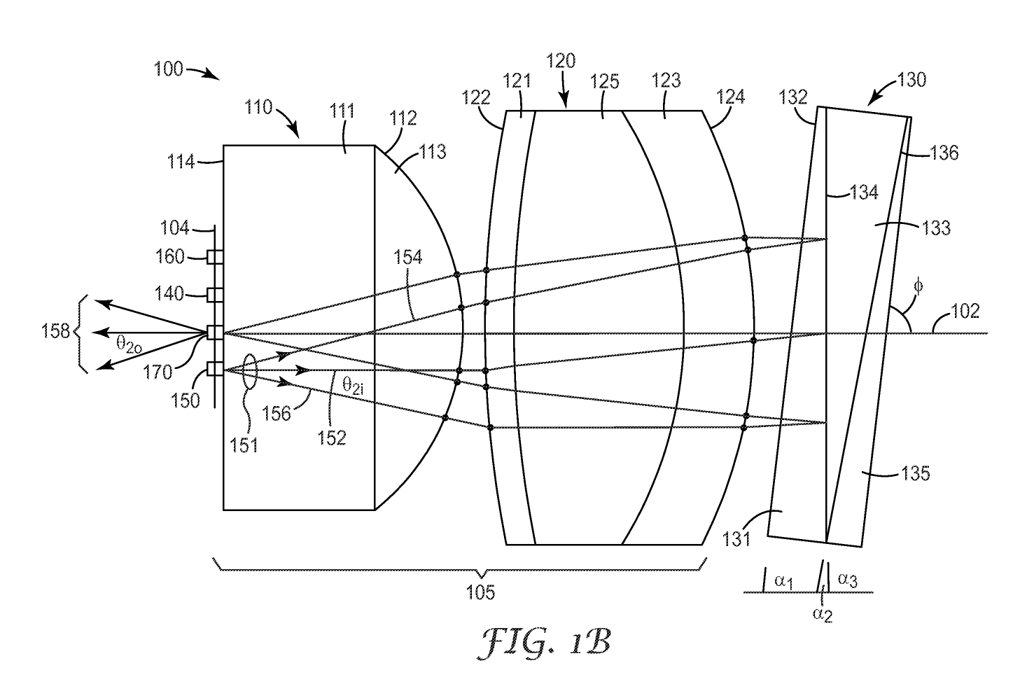

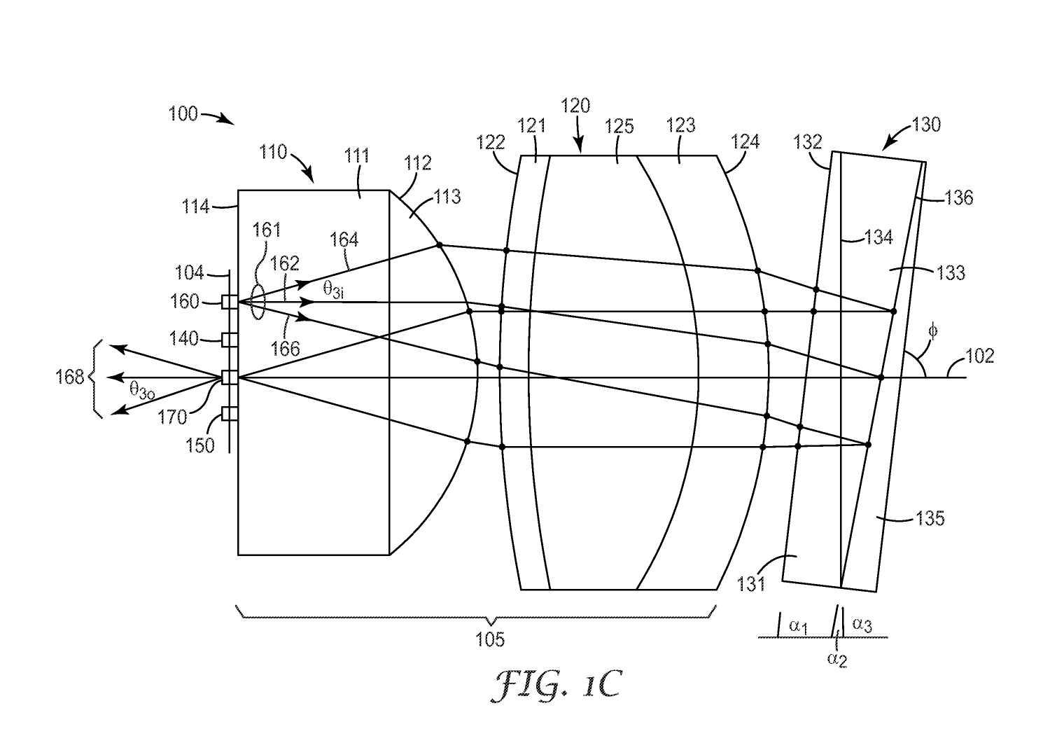

FIGS. 1A-1C shows a cross-section schematic of a color combiner 100 according to one aspect of the disclosure. In FIGS. 1A-1C, the color combiner 100 includes a first light collection optics 105 including a first lens element 110 and a second lens element 120. The first light collection optics 105 includes a light input surface 114 and an optical axis 102 perpendicular to the light input surface 114. A first light source 140, a second light source 150, and an optional third light source 160 are each disposed on a light injection surface 104 that faces the light input surface 114. A light output region 170 is located on the optical axis 102 and disposed on the light injection surface 104. Each of the first, the second, and the optional third light sources 140, 150, 160, are displaced from the optical axis 102. Each of the first, the second, and the optional third light sources 140, 150, 160, are disposed to inject a first color light 141, a second color light 151, and an optional third color light 161, respectively, into the light input surface 114, as described elsewhere.

In one particular embodiment, color combiner 100 further includes a dichroic plate 130 disposed facing the first light collection optics 105 along the optical axis 102, such that the first lens element 110 and the second lens elements 120 are between the dichroic plate 130 and the light input surface 114. The dichroic plate 130 can be disposed at a tilt angle φ to the optical axis, and includes a first dichroic reflector 132 capable of reflecting the first color light 141 and transmitting all other colors of light. The dichroic plate 130 further includes a second dichroic reflector 134 capable of reflecting the second color light 151 and transmitting all other colors of light. The dichroic plate 130 still further includes an optional third dichroic reflector 136 that is capable of reflecting the optional third color light 161. In some cases, for example when only a first and a second light source 140, 150 are included (that is, optional third light source 160 is omitted), second dichroic reflector can be instead a generic reflector such as a broadband mirror, since there is no need to transmit other wavelengths (that is, colors) of light. In some cases, for example when optional third light source 160 is included, optional third dichroic reflector 136 can also be a reflector such as a broadband mirror, since all other colors of light are already reflected by the other dichroic reflectors, prior to reaching the third dichroic reflector 136.

The dichroic plate 130 is fabricated such that each of the first, second, and optional third dichroic reflectors 132, 134, 136, are tilted at a first dichroic tilt angle α1, a second dichroic tilt angle α2, and a third dichroic tilt angle α3, respectively, to the optical axis 102. In some cases, as shown for example in FIGS. 1A-1C, the first dichroic tilt angle α1 can be the same as dichroic plate tilt angle φ, although it can also be different. Each of the first, second, and third dichroic tilt angles α1, α2, α3, can be selected to direct the reflected beams from each of the first, second, and optional third light sources 140, 150, 160, through the light output region 170, as described elsewhere.

In one particular embodiment, first light collection optics 105 can be a light collimator that serves to collimate the light emitted from the first, second, and optional third light sources 140, 150, 160. First light collection optics 105 can include a one lens light collimator (not shown), a two lens light collimator (shown), a diffractive optical element (not shown), or a combination thereof. The two lens light collimator has first lens element 110 that includes a first convex surface 112 disposed opposite the light input surface 114. Second lens element 120 includes a second surface 122 facing the first convex surface 112, and a third convex surface 124 opposite the second surface 122. Second surface 122 can be selected from a convex surface, a planar surface, and a concave surface.

Turning to FIG. 1A, the path of the first color light 141 from first light source 140 can be traced through color combiner 100. First color light 141 includes a first central light ray 142 travelling in the first light propagation direction, and a cone of rays within first input light collimation angle θ1i, the boundaries of which are represented by first boundary light rays 144, 146. The first central light ray 142 is injected from first light source 140 into light input surface 114 in a direction generally parallel to the optical axis 102, passes through first lens element 110, second lens element 120, and reflects from first dichroic reflector 132 such that the reflected beam is coincident with the optical axis 102 as shown. Each of the first boundary light rays 144, 146 are injected into the light input surface 114 in a direction generally at the first input light collimation angle θ1i to the optical axis 102, passes through first lens element 110, second lens element 120, and reflects from first dichroic reflector 132 such that the reflected beams are generally parallel to the optical axis 102 as shown. As can be seen from FIG. 1A, the first light collection optics 105 serve to collimate the first color light 141 passing from the first light source 140 to the dichroic plate 130.

Each of the first central light ray 142 and the first boundary light rays 144, 146, reflect from the first dichroic reflector 132 and travel back through the first light collection optics 105 as collimated light rays parallel to, and centered upon, the optical axis 102. In one particular embodiment as shown in FIG. 1A, the collimated light rays converge to exit the color combiner 100 through the light output region 170 as a first color light beam 148 having a first output collimation angle θ2o.

Turning to FIG. 1B, the path of the second color light 151 from second light source 150 can be traced through color combiner 100. Second color light 151 includes a second central light ray 152 travelling in the second light propagation direction, and a cone of rays within second input light collimation angle θ2i, the boundaries of which are represented by second boundary light rays 154, 156. The second central light ray 152 is injected from second light source 150 into light input surface 114 in a direction generally parallel to the optical axis 102, passes through first lens element 110, second lens element 120, and reflects from second dichroic reflector 134 such that the reflected beam is coincident with the optical axis 102 as shown. Each of the second boundary light rays 154, 156 are injected into the light input surface 114 in a direction generally at the second input light collimation angle θ2i to the optical axis 102, passes through first lens element 110, second lens element 120, and reflects from second dichroic reflector 134 such that the reflected beams are generally parallel to the optical axis 102 as shown. As can be seen from FIG. 1B, the first light collection optics 105 serve to collimate the second color light 151 passing from the second light source 150 to the dichroic plate 130.

Each of the second central light ray 152 and the second boundary light rays 154, 156, reflect from the second dichroic reflector 134 and travel back through the first light collection optics 105 as collimated light rays parallel to, and centered upon, the optical axis 102. In one particular embodiment as shown in FIG. 1B, the collimated light rays converge to exit the color combiner 100 through the light output region 170 as a second color light beam 158 having a second output collimation angle θ2o.

Turning to FIG. 1C, the path of the optional third color light 161 from optional third light source 160 can be traced through color combiner 100. Optional third color light 161 includes a third central light ray 162 travelling in the third light propagation direction, and a cone of rays within third input light collimation angle θ3i, the boundaries of which are represented by third boundary light rays 164, 166. The third central light ray 162 is injected from optional third light source 160 into light input surface 114 in a direction generally parallel to the optical axis 102, passes through first lens element 110, second lens element 120, and reflects from third dichroic reflector 136 such that the reflected beam is coincident with the optical axis 102 as shown. Each of the third boundary light rays 164, 166 are injected into the light input surface 114 in a direction generally at the third input light collimation angle θ3i to the optical axis 102, passes through first lens element 110, second lens element 120, and reflects from third dichroic reflector 136 such that the reflected beams are generally parallel to the optical axis 102 as shown. As can be seen from FIG. 1C, the first light collection optics 105 serve to collimate the optional third color light 161 passing from the optional third light source 160 to the dichroic plate 130.

Each of the third central light ray 162 and the third boundary light rays 164, 166, reflect from the third dichroic reflector 136 and travel back through the first light collection optics 105 as collimated light rays parallel to, and centered upon, the optical axis 102. In one particular embodiment as shown in FIG. 1C, the collimated light rays converge to exit the color combiner 100 through the light output region 170 as an optional third color light beam 168 having a third output collimation angle θ3o.

In one particular embodiment, each of the first, the second, and the third input collimation angles θ1i, θ2i, θ3i can be the same, and injection optics (not shown) associated with each of the first, the second, and the optional third light sources 140, 150, 160, can restrict these input collimation angles to angles between about 10 degrees and about 80 degrees, or between about 10 degrees to about 70 degrees, or between about 10 degrees to about 60 degrees, or between about 10 degrees to about 50 degrees, or between about 10 degrees to about 40 degrees, or between about 10 degrees to about 30 degrees or less. In some cases, the first light collection optics 1θ5 and the dichroic plate 130 can be fabricated such that each of the first, the second, and the third output collimation angles θ1o, θ2o, θ3o can be the same, and also substantially equal to the respective input collimation angles. In one particular embodiment, each of the input collimation angles ranges from about 60 to about 70 degrees, and each of the output collimation angles also ranges from about 60 to about 70 degrees.

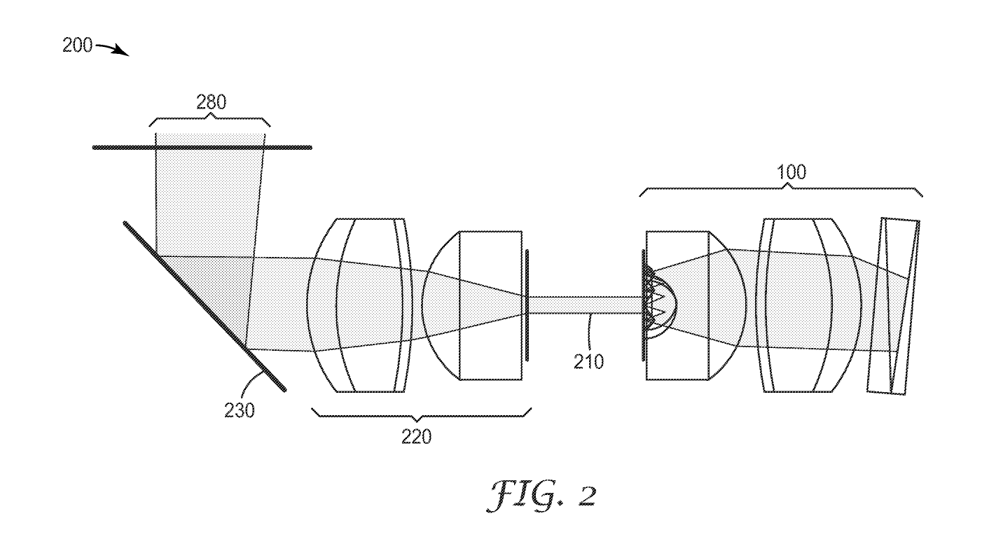

FIG. 2 shows a cross-section schematic of a color combiner system 200 according to one aspect of the disclosure. In FIG. 2, a color combiner 100 as described with reference to FIGS. 1A-1C is paired with a second light collection optics 220 such that the output of the color combiner 100 enters an integrating rod 210 (or a light homogenization tunnel 210) where the colors are further mixed, and is input into the second light collection optics 220. The second light collection optics 220 can be similar to the first light collection optics 1θ5 described previously, and can serve to be a light collimator which expands the combined color light output. In some embodiments, the combined color light output having the first, the second, and the third output collimation angles θ1o, θ2o, θ3o as described previously, can be expanded to a color combined collimated light 280 which has been reflected from an optional broadband mirror 230. The color combined collimated light 280 includes light having a small divergence angle that can be less than about 20 degrees, or less than about 15 degrees, or even less than about 12 degrees.

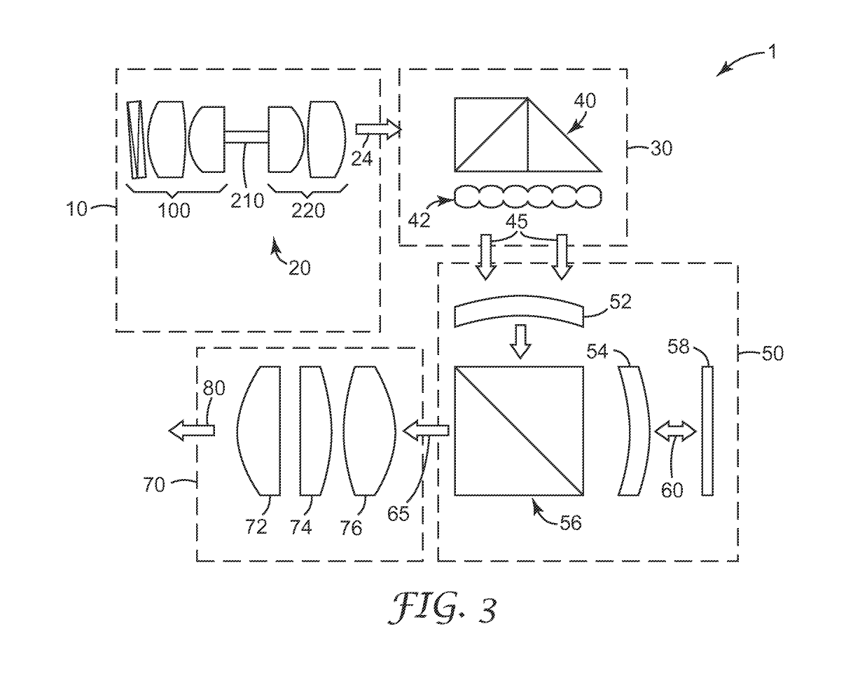

FIG. 3 shows a schematic diagram of an image projector 1, according to one aspect of the disclosure. Image projector 1 includes a color combiner module 10 that is capable of injecting a partially collimated combined color light output 24 into a homogenizing polarization converter module 30 where the partially collimated combined color light output 24 becomes converted to a homogenized polarized light 45 that exits the homogenizing polarization converter module 30 and enters an image generator module 50. The image generator module 50 outputs an imaged light 65 that enters a projection module 70 where the imaged light 65 becomes a projected imaged light 80.

In one aspect, color combiner module 10 includes different wavelength spectrum input light sources that are input through a first light collection optics 105 in color combiner 100, as described elsewhere. The color combiner 100 produces a combined light output that includes the different wavelength spectrum lights passing through a light homogenization tunnel 210. The combined light output passing through light homogenization tunnel 210 then passes through a second light collection optics 220 and exits color combiner module 10 as partially collimated combined color light output 24, as described elsewhere.

In one aspect, the input light sources are unpolarized, and the partially collimated combined color light output 24 is also unpolarized. The partially collimated combined color light output 24 can be a polychromatic combined light that comprises more than one wavelength spectrum of light. The partially collimated combined color light output 24 can be a time sequenced output of each of the received lights. In one aspect, each of the different wavelength spectra of light corresponds to a different color light (for example, red, green and blue), and the combined light output is white light, or a time sequenced red, green and blue light. For purposes of the description provided herein, “color light” and “wavelength spectrum light” are both intended to mean light having a wavelength spectrum range which may be correlated to a specific color if visible to the human eye. The more general term “wavelength spectrum light” refers to both visible and other wavelength spectrums of light including, for example, infrared light.

According to one aspect, each input light source comprises one or more light emitting diodes (LED's). Various light sources can be used such as lasers, laser diodes, organic LED's (OLED's), and non solid state light sources such as ultra high pressure (UHP), halogen or xenon lamps with appropriate collectors or reflectors. Light sources, light collimators, lenses, and light integrators useful in the present invention are further described, for example, in Published U.S. Patent Application No. US 2008/0285129, the disclosure of which is herein included in its entirety.

In one aspect, homogenizing polarization converter module 30 includes a polarization converter 40 that is capable of converting unpolarized partially collimated combined color light output 24 into homogenized polarized light 45. Homogenizing polarization converter module 30 further can include a monolithic array of lenses 42, such as a optional monolithic FEA of lenses described elsewhere that can homogenize and improve the uniformity of the partially collimated combined color light output 24 that exits the homogenizing polarization converter module 30 as homogenized polarized light 45. Representative arrangements of optional FEA associated with the homogenizing polarization converter module 30 are described, for example, in co-pending U.S. Patent Ser. Nos. 61/346,183 entitled FLY EYE INTEGRATOR POLARIZATION CONVERTER (Attorney Docket No. 66247US002, filed May 19, 2010); 61/346,190 entitled POLARIZED PROJECTION ILLUMINATOR (Attorney Docket No. 66249US002, filed May 19, 2010); and 61/346,193 entitled COMPACT ILLUMINATOR (Attorney Docket No. 66360US002, filed May 19, 2010).

In one aspect, image generator module 50 includes a polarizing beam splitter (PBS) 56, representative imaging optics 52, 54, and a spatial light modulator 58 that cooperate to convert the homogenized polarized light 45 into an imaged light 65. Suitable spatial light modulators (that is, image generators) have been described previously, for example, in U.S. Pat. Nos. 7,362,507 (Duncan et al.), 7,529,029 (Duncan et al.); in U.S. Publication No. 2008-0285129-A1 (Magarill et al.); and also in PCT Publication No. WO2007/016015 (Duncan et al.). In one particular embodiment, homogenized polarized light 45 is a divergent light originating from each lens of the optional FEA. After passing through imaging optics 52, 54 and PBS 56, homogenized polarized light 45 becomes imaging light 60 that uniformly illuminates the spatial light modulator. In one particular embodiment, each of the divergent light ray bundles from each of the lenses in the optional FEA illuminates a major portion of the spatial light modulator 58 so that the individual divergent ray bundles overlap each other.

In one aspect, projection module 70 includes representative projection optics 72, 74, 76, that can be used to project imaged light 65 as projected light 80. Suitable projection optics 72, 74, 76 have been described previously, and are well known to those of skill in the art.

Following are a list of embodiments of the present disclosure.

Item 1 is a color combiner having a first light collection optics having a first light input surface and an optical axis; a first and a second light source, each displaced from the optical axis and disposed to inject a first and a second color light into the first light input surface; and a dichroic plate disposed facing the first light collection optics opposite the first light input surface, the dichroic plate including: a first dichroic reflector capable of reflecting the first color light and transmitting other color light; and a second reflector capable of reflecting the second color light, wherein the first dichroic reflector and the second reflector are each tilted such that the first and the second color light are both reflected to exit through the first light input surface along the optical axis, as a combined color light beam.

Item 2 is the color combiner of item 1, wherein the first collection optics comprises light collimation optics.

Item 3 is the color combiner of item 2, wherein the light collimation optics comprises a one lens design, a two lens design, a diffractive optical element, or a combination thereof.

Item 4 is the color combiner of item 1 to item 3, wherein the first collection optics comprises: a first lens having a first convex surface opposite the first light input surface; and a second lens having a second surface facing the first convex surface, and a third convex surface opposite the second surface.

Item 5 is the color combiner of item 1 to item 4, wherein each of the first and second color light include a first divergence angle, and the combined beam includes a second divergence angle that varies from the first divergence angle by no more than 10 percent.

Item 6 is the color combiner of item 1 to item 5, wherein the second reflector comprises a broadband minor.

Item 7 is the color combiner of item 1 to item 6, wherein the second reflector comprises a second dichroic reflector capable of reflecting the second color light and transmitting other color light.

Item 8 is the color combiner of item 1 to item 7, further comprising a third light source displaced from the optical axis and disposed to inject a third color light into the first light input surface, wherein the dichroic plate further comprises a third reflector capable of reflecting the third color light to exit through the first light input surface along the optical axis.

Item 9 is the color combiner of item 8, wherein the third reflector comprises a broadband mirror.

Item 10 is the color combiner of item 8, wherein the third reflector comprises a third dichroic reflector capable of reflecting the third color light and transmitting other color light.

Item 11 is the color combiner of item 1 to item 10, further comprising a light homogenization tunnel disposed to transmit the combined color light beam to a second light collection optics, the second light collection optics expanding the combined color light beam to become a combined color light beam having a small divergence angle.

Item 12 is the color combiner of item 11, wherein the second light collection optics comprises: a third lens centered on the optical axis having a fourth convex surface and a second light input surface opposite the fourth convex surface, capable of transmitting the light exiting the first light input surface to the second light input surface; and a fourth lens centered on the optical axis, the fourth lens having a fifth surface facing the fourth convex surface, and a sixth convex surface opposite the fifth surface, wherein the light entering the second light input surface exits the sixth convex surface as the partially collimated combined color light beam.

Item 13 is the color combiner of item 11 to item 12, wherein the small divergence angle comprises an angle less than about 15 degrees.

Item 14 is the color combiner of item 11 to item 13, wherein the small divergence angle comprises an angle less than about 12 degrees.

Item 15 is a color combiner, comprising: a first lens having a first convex surface, a light input surface opposite the first convex surface, and an optical axis; a second lens centered on the optical axis, the second lens having a second surface facing the first convex surface, and a third convex surface opposite the second surface; a first, a second, and a third light source displaced from the optical axis and disposed to inject a first, a second, and a third color light, respectively, into the light input surface; and a dichroic plate disposed facing the third convex surface, including: a first dichroic reflector capable of reflecting the first color light and transmitting the second and the third color light; a second dichroic reflector capable of reflecting the second color light and transmitting the third color light; and a third reflector capable of reflecting the third color light, wherein the first dichroic reflector, the second dichroic reflector, and the third reflector are each tilted such that the first, the second, and the third color light are each reflected to exit through the input plane along the optical axis as a combined color light beam.

Item 16 is the color combiner of item 15, wherein each of the first and second color light include a first divergence angle, and the combined beam includes a second divergence angle that varies from the first divergence angle by no more than 10 percent.

Item 17 is the color combiner of item 15 or item 16, wherein the third reflector is a broadband mirror.

Item 18 is the color combiner of item 15 to item 17, wherein the third reflector is a third dichroic reflector capable of reflecting the third color light and transmitting other color light.

Item 19 is the color combiner of item 15 to item 18, further comprising a collection optics that includes: a third lens having a fourth convex surface, a second light input surface opposite the fourth convex surface, and a light homogenization tunnel disposed on the optical axis and capable of transmitting the light exiting the input surface to the second light input surface; and a fourth lens centered on the optical axis, the fourth lens having a fifth surface facing the fourth convex surface, and a sixth convex surface opposite the fifth surface, wherein the light entering the second light input surface exits the sixth convex surface as an expanded light beam having a small divergence angle.

Item 20 is the color combiner of item 19, wherein the small divergence angle comprises an angle less than about 15 degrees.

Item 21 is the color combiner of item 19 or item 20, wherein the small divergence angle comprises an angle less than about 12 degrees.

Item 22 is an image projector, comprising: the color combiner of item 11 or item 19; a polarization converter disposed to accept the first, the second, and the third color light and output a polarized first, second, and third color light; a spatial light modulator disposed to impart an image to the polarized first, second, and third color light; and projection optics.

Item 23 is the image projector of item 22, wherein the spatial light modulator comprises a liquid crystal on silicon (LCoS) imager or a transmissive liquid crystal display (LCD).

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A color combiner, comprising:
a first light collection optics having a first light input surface and an optical axis;
a first and a second light source, each displaced from the optical axis and disposed to inject a first and a second color light into the first light input surface; and
a dichroic plate disposed facing the first light collection optics opposite the first light input surface, the dichroic plate including:
a first dichroic reflector capable of reflecting the first color light and transmitting other color light; and
a second reflector capable of reflecting the second color light,
wherein the first dichroic reflector and the second reflector are each tilted such that the first and the second color light are both reflected to exit through the first light input surface along the optical axis, as a combined color light beam.

2. The color combiner of claim 1, wherein the first light collection optics comprises light collimation optics.

3. The color combiner of claim 2, wherein the light collimation optics comprises a one lens design, a two lens design, a diffractive optical element, or a combination thereof.

4. The color combiner of claim 1, wherein the first light collection optics comprises:
a first lens having a first convex surface opposite the first light input surface; and
a second lens having a second surface facing the first convex surface, and a third convex surface opposite the second surface.

5. The color combiner of claim 1, wherein each of the first and second color light include a first divergence angle, and the combined color light beam includes a second divergence angle that varies from the first divergence angle by no more than 10 percent.

6. The color combiner of claim 1, wherein the second reflector comprises a broadband mirror.

7. The color combiner of claim 1, wherein the second reflector comprises a second dichroic reflector capable of reflecting the second color light and transmitting other color light.

8. The color combiner of claim 1, further comprising a third light source displaced from the optical axis and disposed to inject a third color light into the first light input surface, wherein the dichroic plate further comprises a third reflector capable of reflecting the third color light to exit through the first light input surface along the optical axis.

9. The color combiner of claim 8, wherein the third reflector comprises a broadband mirror.

10. The color combiner of claim 8, wherein the third reflector comprises a third dichroic reflector capable of reflecting the third color light and transmitting other color light.

11. The color combiner of claim 1, further comprising a light homogenization tunnel disposed to transmit the combined color light beam to a second light collection optics, the second light collection optics expanding the combined color light beam to become an expanded combined color light beam having a small divergence angle.

12. The color combiner of claim 11, wherein the second light collection optics comprises:
a third lens centered on the optical axis having a fourth convex surface and a second light input surface opposite the fourth convex surface, capable of transmitting the light exiting the first light input surface to the second light input surface; and
a fourth lens centered on the optical axis, the fourth lens having a fifth surface facing the fourth convex surface, and a sixth convex surface opposite the fifth surface,
wherein the light entering the second light input surface exits the sixth convex surface as the expanded combined color light beam.

13. The color combiner of claim 11, wherein the small divergence angle comprises an angle less than about 15 degrees.

14. The color combiner of claim 11, wherein the small divergence angle comprises an angle less than about 12 degrees.

15. A color combiner, comprising:
a first lens having a first convex surface, a first light input surface opposite the first convex surface, and an optical axis;
a second lens centered on the optical axis, the second lens having a second surface facing the first convex surface, and a third convex surface opposite the second surface;
a first, a second, and a third light source displaced from the optical axis and disposed to inject a first, a second, and a third color light, respectively, into the first light input surface; and
a dichroic plate disposed facing the third convex surface, including:
a first dichroic reflector capable of reflecting the first color light and transmitting the second and the third color light;
a second dichroic reflector capable of reflecting the second color light and transmitting the third color light; and
a third reflector capable of reflecting the third color light,
wherein the first dichroic reflector, the second dichroic reflector, and the third reflector are each tilted such that the first, the second, and the third color light are each reflected to exit through the first light input surface along the optical axis as a combined color light beam.

16. The color combiner of claim 15, wherein each of the first and second color light include a first divergence angle, and the combined color light beam includes a second divergence angle that varies from the first divergence angle by no more than 10 percent.

17. The color combiner of claim 15, wherein the third reflector is a broadband mirror.

18. The color combiner of claim 15, wherein the third reflector is a third dichroic reflector capable of reflecting the third color light and transmitting other color light.

19. The color combiner of claim 15, further comprising a collection optics that includes:
a third lens having a fourth convex surface, a second light input surface opposite the fourth convex surface, and a light homogenization tunnel disposed on the optical axis and capable of transmitting the light exiting the first light input surface to the second light input surface; and
a fourth lens centered on the optical axis, the fourth lens having a fifth surface facing the fourth convex surface, and a sixth convex surface opposite the fifth surface,
wherein the light entering the second light input surface exits the sixth convex surface as an expanded combined color light beam having a small divergence angle.

20. The color combiner of claim 19, wherein the small divergence angle comprises an angle less than about 15 degrees.

21. The color combiner of claim 19, wherein the small divergence angle comprises an angle less than about 12 degrees.

22. An image projector, comprising:
the color combiner of claim 11 or claim 19;
a polarization converter disposed to accept the first, the second, and the third color light and output a polarized first, second, and third color light;
a spatial light modulator disposed to impart an image to the polarized first, second, and third color light; and
projection optics.

23. The image projector of claim 22, wherein the spatial light modulator comprises a liquid crystal on silicon (LCoS) imager or a transmissive liquid crystal display (LCD).
